(19) United States
(12) Patent Application Publication
(10) Pub. No.: US 2025/0262115 A1
(43) Pub. Date: Aug. 21, 2025

(54) MASSAGE MECHANISM AND MASSAGER

(71) Applicant: SKG Health Technologies Co., Ltd., Shenzhen (CN)

(72) Inventors: Wentao LIAO, Shenzhen (CN); Jincan WANG, Shenzhen (CN); Jian ZHANG, Shenzhen (CN)

(73) Assignee: SKG Health Technologies Co., Ltd., Shenzhen (CN)

(21) Appl. No.: 19/016,942

(22) Filed: Jan. 10, 2025

(30) Foreign Application Priority Data
Feb. 19, 2024 (CN) 202410187841.1
Feb. 19, 2024 (CN) 202420307072.X

(51) Int. Cl. A61H 15/00

(52) U.S. Cl. CPC A61H 15/0078; A61H 2015/0042; A61H 2201/1215; A61H 2201/1418; A61H 2201/149

(57) ABSTRACT

A massage mechanism and a massager are provided. The massage mechanism includes a housing, a driving motor, two eccentric wheels, two swing rods, and two massage heads. Each swing rod has a first end and a second end opposite to the first end in a length direction of the swing rod. Second ends of the two swing rods are respectively received in two elongated slots to allow each second end to linearly reciprocate and limit motion of each second end. In a process of 360° rotation of the first end of each swing rod around the central axis of each eccentric wheel under the drive of each eccentric wheel, the two massage heads are close to or away from each other, and are configured to perform a yaw motion around a rotation axis parallel to the central axis of each of the two eccentric wheels in a preset angle range.

### CROSS-REFERENCE TO RELATED APPLICATIONS

This application claims priority under 35 U.S.C. § 119 (a) to Chinese Patent Application No. 202410187841.1, filed on Feb. 19, 2024, and Chinese Patent Application No. 202420307072.X, filed on Feb. 19, 2024, the entire disclosures of which are incorporated herein by reference.

### TECHNICAL FIELD

This disclosure relates to the field of massage device technology, and in particular to a massage mechanism and a massager.

### BACKGROUND

With continuous improvement of living standards, more and more people begin to pay attention to their own physical health. When people feel physically sick, such as backache, neck and shoulder pain, leg pain, or the like, people use massagers to massage their own bones, tendons, and muscles in order to relieve fatigue, treat, or prevent pain.

### SUMMARY

In a first aspect, a massage mechanism is provided in embodiments of the present disclose. The massage mechanism includes a housing, a driving motor, two eccentric wheels, two swing rods, and two massage heads. The housing is provided with two elongated slots. The driving motor is fixedly disposed at the housing. The two eccentric wheels are disposed at the housing. The two eccentric wheels are in transmission connection with the driving motor to rotate under the drive of the driving motor. Each of the two eccentric wheels is provided with an eccentric connection portion. The eccentric connection portion is spaced apart from a central axis of each of the two eccentric wheels. The two swing rods are symmetrically arranged. Each of the two swing rods has a first end and a second end opposite to the first end in a length direction of each of the two swing rods. The first end is hinged to the eccentric connection portion to rotate 360° around the central axis of each of the two eccentric wheels along with the eccentric connection portion. Second ends of the two swing rods are respectively received in the two elongated slots to allow each of the second ends to linearly reciprocate and limit motion of each of the second ends in a direction perpendicular to the length direction of each of the two swing rods. The two massage heads extend out of the housing and is configured to massage a target massage area. The two massage heads are fixedly connected to the second ends of the two swing rods respectively. In a process of 360° rotation of the first end of each of the two swing rods around the central axis of each of the two eccentric wheels under the drive of each of two eccentric wheels, the two massage heads are close to or away from each other, and each are configured to perform a yaw motion around a rotation axis parallel to the central axis of each of the two eccentric wheels in a preset angle range.

In a second aspect, a massager is provided in embodiments of the present disclosure. The massager includes a massage mechanism. The massage mechanism includes a housing, a driving motor, two eccentric wheels, two swing rods, and two massage heads. The housing is provided with two elongated slots. The driving motor is fixedly disposed at the housing. The two eccentric wheels are disposed at the housing. The two eccentric wheels are in transmission connection with the driving motor to rotate under the drive of the driving motor. Each of the two eccentric wheels is provided with an eccentric connection portion. The eccentric connection portion is spaced apart from a central axis of each of the two eccentric wheels. The two swing rods are symmetrically arranged. Each of the two swing rods has a first end and a second end opposite to the first end in a length direction of each of the two swing rods. The first end is hinged to the eccentric connection portion to rotate 360° around the central axis of each of the two eccentric wheels along with the eccentric connection portion. Second ends of the two swing rods are respectively received in the two elongated slots to allow each of the second ends to linearly reciprocate and limit motion of each of the second ends in a direction perpendicular to the length direction of each of the two swing rods. The two massage heads extend out of the housing and is configured to massage a target massage area. The two massage heads are fixedly connected to the second ends of the two swing rods respectively. In a process of 360° rotation of the first end of each of the two swing rods around the central axis of each of the two eccentric wheels under the drive of each of two eccentric wheels, the two massage heads are close to or away from each other, and each are configured to perform a yaw motion around a rotation axis parallel to the central axis of each of the two eccentric wheels in a preset angle range.

### BRIEF DESCRIPTION OF THE DRAWINGS

To describe the technical solutions in embodiments of the present disclosure or in related art more clearly, the following briefly introduces the accompanying drawings required for describing the embodiments or the related art. Apparently, the accompanying drawings in the following description show merely some embodiments of the present disclosure. For those of ordinary skill in the art, other accompanying drawings may also be obtained according to structures shown in these accompanying drawings without creative efforts.

FIG. 1 is a schematic structural view of an exterior of a housing of a massage mechanism according to some embodiments of the present disclosure.

FIG. 2 is a schematic structural view of an interior of a housing of a massage mechanism according to some embodiments of the present disclosure.

FIG. 3 is a schematic structural view of an exterior of a housing of a massage mechanism according to some embodiments of the present disclosure.

FIG. 4 is a schematic structural view of an eccentric wheel of a massage mechanism according to some embodiments of the present disclosure.

FIG. 5 is a schematic structural view of a swing rod of a massage mechanism according to some embodiments of the present disclosure.

FIG. 6 is a schematic structural view of a massage mechanism with two through holes defined on a housing surface according to some embodiments of the present disclosure.

FIG. 7 is a schematic structural view of two swing rod covering a cover plate of a massage mechanism according to some embodiments of the present disclosure.

FIG. 8 is a schematic structural view of a flexible housing of a massage mechanism according to some embodiments of the present disclosure.

FIG. 9 is a schematic structural view of a housing surface of a massage mechanism according to some embodiments of the present disclosure.

FIG. 10 is a structural schematic view of a massager according to some embodiments of the present disclosure.

Reference signs in the accompanying drawings are described as follows: massage mechanism 100, housing 10, elongated slot 11, rib 111, rib top-surface 1111, oil storage groove 112, oil storage hole 113, housing surface 12, through hole 121, recess 122, driving motor 20, eccentric wheel 30, eccentric connection portion 31, cam surface 32, swing rod 40, first end 41, second end 42, first connection arm 43, second connection arm 44, extension portion 441, reinforcing structure 45, first reinforcing structure 451, second reinforcing structure 452, massage head 50, first massage head 51, second massage head 52, cover plate 60, elongated hole 61, flexible housing 70, opening hole 71, massage housing 80, first housing part 81, second housing part 82, massager 200.

### DETAILED DESCRIPTION

Embodiments of the present disclosure are described in detail below. Examples of the embodiments are illustrated in the accompanying drawings, in which the same or similar reference signs denote the same or similar elements or the elements having the same or similar functions throughout. The embodiments described below by reference to the accompanying drawings are exemplary, are only used to explain the present disclosure, and cannot be understood as a limitation to the present disclosure.

After the user uses an existing massager for a long time, it is easy to wear the skin, resulting in a less comfortable massage experience.

Embodiments of the present disclosure provide a massage mechanism and a massager, to solve at least one of the technical problems described above.

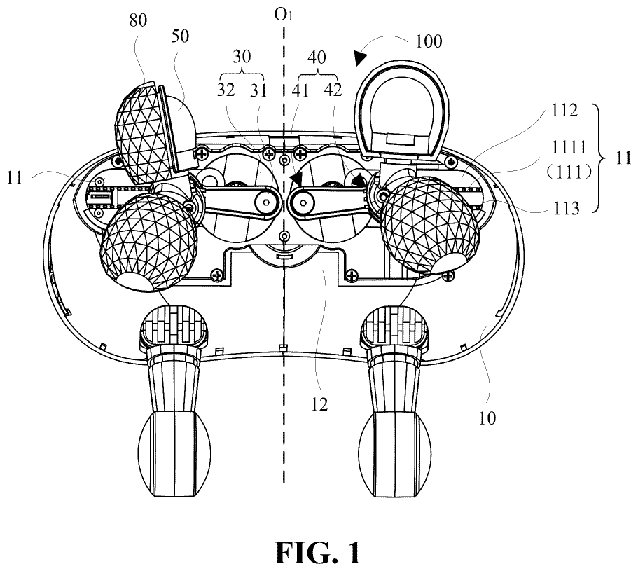

Referring to FIG. 1 to FIG. 4, a massage mechanism 100 is provided in an embodiment of the present disclosure. The massage mechanism 100 includes a housing 10, a driving motor 20, two eccentric wheels 30, two swing rods 40 symmetrically arranged, and two massage heads 50 symmetrically arranged. The housing 10 is provided with two elongated slots 11. The driving motor 20 is fixedly disposed at the housing 10. The two eccentric wheels 30 are disposed at the housing 10. The two eccentric wheels 30 are in transmission connection with the driving motor 20 to rotate under the drive of the driving motor 20. Each eccentric wheel 30 is provided with an eccentric connection portion 31. The eccentric connection portion 31 is spaced apart from a central axis of the eccentric wheel 30. Each of the two swing rods 40 symmetrically arranged has a first end 41 and a second end 42 opposite to the first end 41 in the length direction of the swing rod. The first end 41 is hinged to the eccentric connection portion 31 to rotate 360° around the central axis of the eccentric wheel 30 along with the eccentric connection portion 31. Second ends 42 of the two swing rods 40 are respectively received in the two elongated slots 11, to allow each second end 42 to linearly reciprocate and limit motion of the second end 42 in a direction perpendicular to the length direction of the swing rod 40. The two massage heads 50 extend out of the housing 10 to massage a target massage area. The two massage heads 50 are fixedly connected to the second ends 42 of the two swing rods 40 respectively. In a process of 360° rotation of the first end 41 of each of the two swing rods 40 around the central axis of the eccentric wheel 30 under the drive of the eccentric wheel 30, the two massage heads 50 are close to or away from each other, and each are configured to perform a yaw motion around a rotation axis parallel to the central axis of the eccentric wheel 30 in a preset angle range.

In the massage mechanism 100 of embodiments of the present disclosure, the two eccentric wheels 30 and the two massage heads 50 are connected through the two swing rods 40, respectively. The massage head 50 is fixedly connected to the second end 42 of the swing rod 40. The second end 42 linearly reciprocates in the elongated slot 11. The massage head 50, along with the second end 42, performs a small amplitude of the yaw motion around the rotation axis parallel to the central axis of the eccentric wheel 30 in the preset angle range, and does not rotate 360° along with the eccentric wheel 30. Therefore, after the two massage heads 50 contact with the skin of the user, the two massage heads 50 only move on a fixed plane parallel to the plane where the elongated slots 11 are defined, and the movement amplitude of the two massage heads 50 at the target massage area is relatively small. Thus, after the user is massaged for a long time, it is not easy to wear the skin of the user, and the massage comfort is improved.

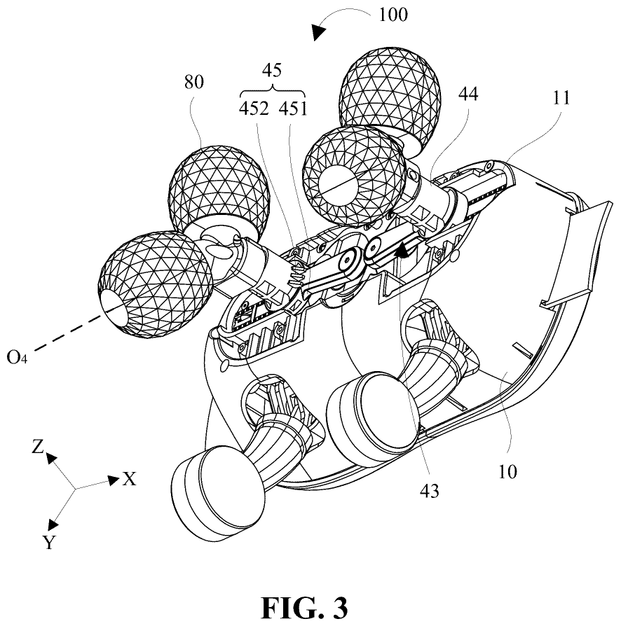

Specifically, the housing 10 may serve as a mounting carrier for the driving motor 20, the eccentric wheel 30, and other elements, and protect the driving motor 20, the eccentric wheel 30, and other elements. The housing 10 may be made of a plastic material, so that the massage mechanism 100 is relatively lightweight as a whole. The housing 10 is provided with the two elongated slots 11, and the two elongated slots 11 are symmetrical about a central axis (as shown by a dotted line O₁ in FIG. 1) of the housing 10 extending in the width direction of the housing 10. A length extension direction of each of the two elongated slots 11 is parallel to a length direction of the housing 10 (as shown by X direction in FIG. 3). An extension direction of the width of each of the two elongated slots 11 is parallel to a width direction of the housing 10 (as shown by Y direction in FIG. 3). An extension direction of the depth of each of the two elongated slots 11 is parallel to a height direction of the housing 10 (as shown by Z direction in FIG. 3).

The driving motor 20 is fixedly disposed at the housing 10, and specifically, may be fixedly mounted inside the housing 10. A power output direction of the driving motor 20 (that is, a direction of a motor output shaft) may be parallel to the width direction of the housing 10. The number of driving motors 20 may be one or more. When there is one driving motor 20, an internal space of the housing 10 that is occupied by the driving motor can be reduced and the cost can be saved.

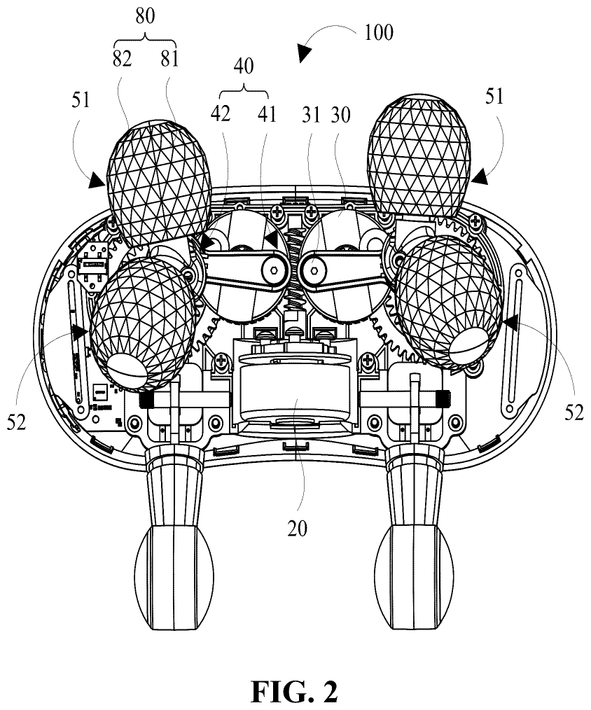

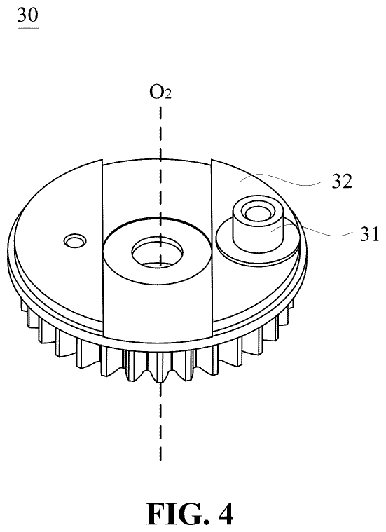

The two eccentric wheels 30 are disposed at the housing 10, and specifically, may be partially located inside the housing 10 and partially located outside the housing 10. The two eccentric wheels 30 are symmetrical about the central axis of the housing 10 extending in the width direction of the housing 10. A direction of a central axis (as shown by a dotted line O₂ in FIG. 4) of the eccentric wheel 30 may be parallel to the height direction of the housing 10. The two eccentric wheels 30 are in transmission connection with the driving motor 20. The driving motor 20 may directly drive the two eccentric wheels 30 to rotate, or indirectly drive the two eccentric wheels 30 to rotate. Referring to FIG. 2, in an example, when the driving motor 20 indirectly drives the two eccentric wheels 30 to rotate, the driving motor 20 transmits power to some intermediate gear members first, and then transmits the power to the two eccentric wheels 30. When there is one driving motor 20, one driving motor 20 is located at a middle position of the two eccentric wheels 30, so that one driving motor 20 can be utilized to drive the two eccentric wheels 30 to rotate synchronously, thereby driving the two swing rods 40 to move, and realizing massage by the two massage heads 50. Referring to FIG. 4, the eccentric connection portion 31 is further disposed on each eccentric wheel 30. The eccentric connection portion 31 is spaced apart from the central axis of the eccentric wheel 30. The eccentric connection portion 31 is located at one side of the eccentric wheel 30 facing the housing 10 to be connected to the corresponding swing rod 40.

The two swing rods 40 are located at one side of the housing 10 facing outward and are symmetrical about the central axis of the housing 10 extending in the width direction of the housing 10. Each swing rod 40 has the first end 41 and the second end 42 opposite to the first end 41 in the length direction of the swing rod. The first end 41 defines a rotating-axis hole, and the rotating-axis hole is sleeved on the eccentric connection portion 31, so that the first end 41 can be hinged to the eccentric connection portion 31. When the driving motor 20 drives the eccentric wheel 30 to rotate, the first end 41 rotates 360°, along with the eccentric connection portion 31, about the central axis of the eccentric wheel 30. The width of the second end 42 is greater than the width of the first end 41 (when each of the first end 41 and the second end 42 is substantially circular, the width herein is an outer diameter). The second end 42 is received in the elongated slot 11, and the width of the elongated slot 11 is in fit with the width of the second end 42. For example, the width of the elongated slot 11 is equal to the width of the second end 42, or the width of the elongated slot 11 is slightly greater than the width of the second end 42. Since the elongated slot 11 is in a long strip shape, it is possible to limit the motion of the second end 42 in the direction perpendicular to the length direction of the swing rod 40, while allowing the second end 42 to linearly reciprocate in the length direction of the elongated slot 11.

The two massage heads 50 extends out of the housing 10 and configured to contact the target massage area, for example, apply an active force to massage the target massage area. The target massage area may be the neck and other parts of the user. When massaging, the two massage heads 50 may be respectively located at two sides of the target massage area. The two massage heads 50 are symmetrical about the central axis of the housing 10 extending in the width direction of the housing. It may be noted that, in embodiments of the present disclosure, “two” may be two or two groups. When there are two massage heads 50, the two massage heads 50 are symmetrical about the central axis of the housing 10 extending in the width direction of the housing. When there are two groups of massage heads 50, the two groups of massage heads 50 are symmetrical about the central axis of the housing 10 extending in the width direction of the housing. Each group of massage heads 50 may include one or more massage heads 50. For example, each group of massage heads 50 may include two massage heads 50. Each massage head 50 is substantially spherical to improve the massage comfort. The two massage heads 50 are fixedly connected to the second ends 42 of the two swing rods 40, respectively. The fixed connection herein means that after the massage head 50 is mounted to the second end 42 of the swing rod 40, the massage head 50 and the swing rod 40 do not move relative to each other, for example, do not rotate or move relative to each other. However, the massage head 50 and the swing rod 40 may be detachable or non-detachable relative to each other, which is not limited herein. Alternatively, the massage head 50 may be directly connected to the swing rod 40, or indirectly connected to the swing rod 40 through an extension portion 441 in the following. In a process of 360° rotation of the first end 41 of each of the two swing rods 40 around the central axis of the eccentric wheel 30 under the drive of the eccentric wheel 30, the two massage heads 50 are close to or away from each other in the length direction of the housing 10, and each are configured to perform the yaw motion around the rotation axis parallel to the central axis of the eccentric wheel 30 in the preset angle range.

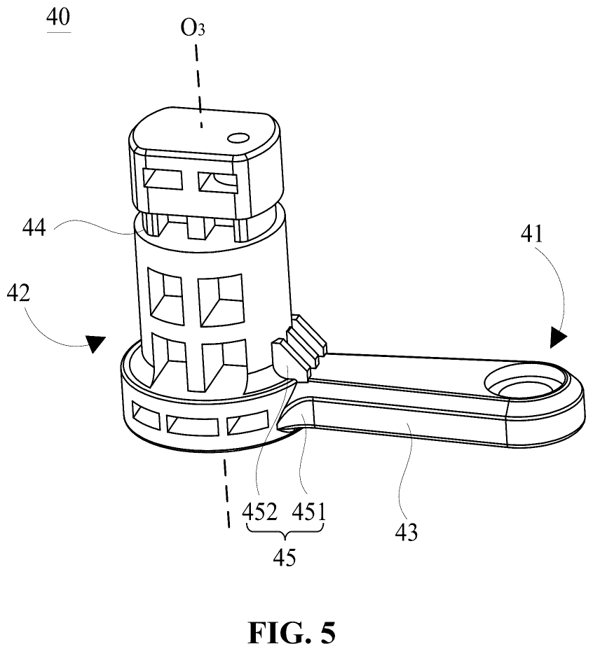

The rotation axis parallel to the central axis of the eccentric wheel 30 may be a central axis (as shown by a dashed line O₃ in FIG. 5) of the second end 42. The yaw motion includes rotation around the fore-mentioned rotation axis towards in a direction close to the target massage area and rotation around the fore-mentioned rotation axis towards a direction away from the target massage area. The preset angle range may be set according to actual situations, as long as the two massage heads 50 can perform a small amplitude of the yaw motion around the rotation axis parallel to the central axis of the eccentric wheel 30, which is not limited herein. For example, the preset angle range may be set within 45°, and the two massage heads 50 can rotate around the rotation axis in the direction close to the target massage area in the angle range of 45°, and rotate around the rotation axis in the direction away from the target massage area in the angle range of 45°.

The overall operation process of the massage mechanism 100 in embodiments of the present disclosure is as follows. The driving motor 20 drives the two eccentric wheels 30 to rotate, and the corresponding eccentric connection portion 31 on each eccentric wheel 30 rotates 360° around the central axis of the eccentric wheel 30. Since the first end 41 of the swing rod 40 is hinged to the eccentric connection portion 31, the first end 41 of the swing rod 40 rotates 360°, along with the corresponding eccentric connection portion 31, around the central axis of the eccentric wheel 30. When the first ends 41 of the two swing rods 40 rotate, the second ends 42 of the two swing rods 40 are driven to linearly reciprocate, respectively. The second ends 42 of the two swing rods 40 are respectively received in the two elongated slots 11 to limit the second ends 42, that is, to limit the motion of each second end 42 in the direction perpendicular to the length direction of the corresponding swing rod 40 while allowing each second end 42 to linearly reciprocate. When the second ends 42 of the two swing rods 40 linearly reciprocate, the two massage heads 50 fixedly connected to the second ends 42 of the two swing rods 40 are driven to linearly reciprocate, so that the two massage heads 50 are close to or away from each other. Meanwhile, the two massage heads 50 each perform a yaw motion around the rotation axis parallel to the central axis of the eccentric wheel 30 in the preset angle range, so as to massage the target massage area.

Referring to FIG. 1 to FIG. 3, and FIG. 5, in some embodiments, the housing 10 has a housing surface 12. The driving motor 20 is disposed at one side of the housing surface 12 facing the interior of the housing 10. The two swing rods 40 are disposed at one side of the housing surface 12 facing the exterior of the housing 10. Each swing rod 40 includes a first connection arm 43 and a second connection arm 44 connected to the first connection arm 43. The first connection arm 43 is hinged to the eccentric connection portion 31. The first connection arm 43 extends from the first end 41 to the second end 42 and is close to the housing surface 12. The second connection arm 44 extends from the second end 42 in a direction away from the housing surface 12 to be fixedly connected to the corresponding massage head 50.

Specifically, the swing rod 40 is substantially L-shaped. The first connection arm 43 extends from the first end 41 to the second end 42 and is close to the housing surface 12. The second connection arm 44 extends from the second end 42 in the direction away from the housing surface 12, and the length of the L-shaped swing rod 40 extending towards the target massage area is made to be as short as possible. Thus, during massage, the length of the arm of force of the counterforce applied to the swing rod 40 by the target massage area can be shortened, so that the mechanical strength of the swing rod 40 can be improved.

Referring to FIG. 3 and FIG. 5, in some embodiments, a reinforcing structure 45 is disposed at a connection of the first connection arm 43 and the second connection arm 44. The reinforcing structure 45 includes a first reinforcing structure 451 disposed in a length direction of the first connection arm 43 and connected to the second connection arm 44, and/or a second reinforcing structure 452 disposed in a length direction of the second connection arm 44 and connected to the first connection arm 43.

Specifically, the reinforcing structure 45 may only include the first reinforcing structure 451. Alternatively, the reinforcing structure 45 may only include the second reinforcing structure 452. Alternatively, the reinforcing structure 45 includes both the first reinforcing structure 451 and the second reinforcing structure 452. The reinforcing structure 45 can increase the structural strength of the swing rod 40. Thus, during massage, the possibility that the swing rod 40 is cracked due to the counterforce by the target massage area can be reduced.

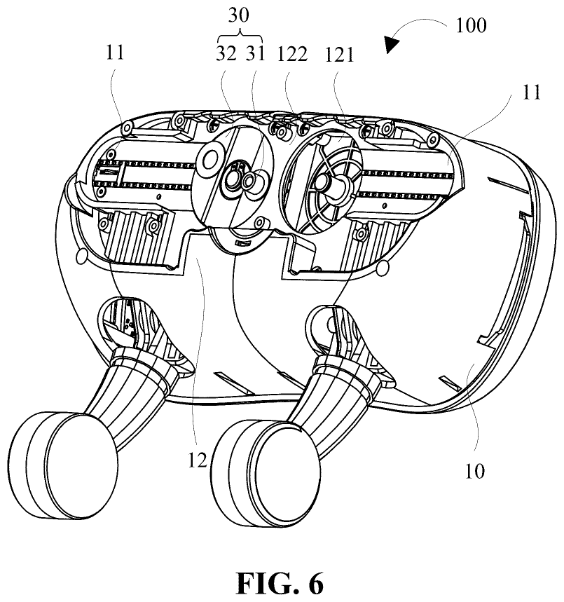

Referring to FIG. 1 and FIG. 6, in some embodiments, two through holes 121 are defined on the housing surface 12. The interior of the housing 10 is in communication with the exterior of the housing 10 through the two through holes 121. The two eccentric wheels 30 are respectively disposed in the two through holes 121. Each eccentric wheel 30 has a cam surface 32 facing the exterior of the housing 10. The eccentric connection portion 31 extends from the cam surface 32 and is at least partially located outside the through hole 121 to be hinged to the first end 41 of the swing rod 40.

Specifically, there may be a height difference between the cam surface 32 and the housing surface 12. The height difference may be in a range of ±2 mm. For example, the height difference between the cam surface 32 and the housing surface 12 may be −2 mm, −1 mm, 0 mm, 1 mm, 2 mm, or any other value in the range of ±2 mm, which is not limited herein. The eccentric connection portion 31 extends from the cam surface 32 and is hinged to the first end 41 of the swing rod 40. Thus, the length of part of the eccentric connection portion 31 that is connected to the first end 41 of the swing rod 40 in the axial direction (as shown by a direction of Z axis in FIG. 3) can be shortened, to improve the mechanical strength. In addition, the mechanical overhead during the movement of the swing rod 40 can also be reduced.

Referring to FIG. 3 and FIG. 5, in some embodiments, an angle between a length extension direction of the first connection arm 43 and a length extension direction of the second connection arm 44 ranges from 80° to 100°.

Specifically, the swing rod 40 is substantially L-shaped. The first connection arm 43 is close to the housing surface 12. Changing the angle between the length extension direction of the first connection arm 43 and the length extension direction of the second connection arm 44 is equivalent to changing an inclination angle of the second connection arm 44 relative to the first connection arm 43. If the angle range is set to be too large or too small, the inclination angle of the second connection arm 44 may be too large or too small. However, if the inclination angle of the second connection arm 44 is too large or too small, it is necessary to lengthen the length of the second connection arm 44 to contact the target massage area, thus resulting in a decrease in the mechanical strength of the swing rod 40.

In embodiments of the present disclosure, the angle range of the L-shaped swing rod 40, that is, the range of the angle between the length extension direction of the first connection arm 43 and the length extension direction of the second connection arm 44, is set to be of 80° to 100°, so that the second connection arm 44 of the swing rod 40 facing the target massage area only needs to have a short length to contact the target massage area. The specific angle may be set according to actual situations. For example, the angle between the length extension direction of the first connection arm 43 and the length extension direction of the second connection arm 44 may be set to be 80°, 85°, 90°, 95°, 100°, or any other value between 80° and 100°, which is not limited herein.

Referring to FIG. 1, in some embodiments, at least one rib 111 is disposed in each elongated slot 11 and extends in a linear motion direction of the second end 42. Each rib 111 has a rib top-surface 1111 facing the exterior of the housing 10. The rib top-surface 1111 is configured to be in sliding fit with the second end 42 when the second end 42 linearly reciprocate along the corresponding elongated slot 11. A plane that is flush with the rib top-surface 1111 in each elongated slot 11 is recessed towards the interior of the housing 10 to define at least two oil storage grooves 112. The at least two oil storage grooves 112 and the at least one rib 111 are alternately arranged in a width direction of the elongated slot 11.

Specifically, when the user uses the massager 200 to massage, the second end 42 of the swing rod 40 may be subjected to an axial pressing force (that is, counterforce) by the target massage area. The rib 111 is disposed in the elongated slot 11, so that the second end 42 of the swing rod 40 can be supported when the swing rod 40 is subjected to the axial pressing force.

In addition, the plane that is flush with the rib top-surface 1111 in each elongated slot 11 is recessed towards the interior of the housing 10 to define the oil storage groove 112. The oil storage groove 112 can be used for storing lubricating oil. When the second end 42 linearly reciprocates in the elongated slot 11, the lubricating oil stored in the oil storage groove 112 can reduce the sliding friction during the motion, so that the obstruction or even stop of the motion of the swing rod 40 due to excessive sliding friction can be avoided.

Referring to FIG. 1, in some embodiments, the rib top-surface 1111 is recessed towards the interior of the housing 10 to define multiple oil storage holes 113. The multiple oil storage holes 113 are defined at intervals in the linear motion direction of the second end 42.

Specifically, similar to the oil storage groove 112, the oil storage hole 113 can also be used for storing lubricating oil. When the second end 42 of the swing rod 40 linearly reciprocates along the elongated slot 11 and the rib top-surface 1111 is in sliding fit with the second end 42, the lubricating oil stored in the oil storage hole 113 can further reduce sliding friction during the motion, so that the obstruction or even stop of the motion of the swing rod 40 due to excessive sliding friction can be further avoided.

Referring to FIG. 1, in some embodiments, two spaced ribs 111 are disposed in each elongated slot 11. The two ribs 111 are symmetrical in the width direction of the elongated slot 11.

Specifically, the second end 42 of the swing rod 40 has a certain width. Compared with only one rib 111, the two ribs 111 can support the second end 42 more stably. Meanwhile, compared with more ribs 111, the two ribs 111 are sufficient to stably support the second end 42, so that the space at the bottom of the elongated slot 11 can be fully utilized to define the oil storage groove 112.

Referring to FIG. 5 and FIG. 6, in some embodiments, the massage mechanism 100 further includes a cover plate 60. The housing surface 12 is recessed towards the interior of the housing 10 to define a recess 122. The two swing rods 40 are at least partially received in the recess 122 and covered with the cover plate 60. The cover plate 60 defines two elongated holes 61. The two elongated holes 61 respectively allow the second ends 42 of the two swing rods 40 to linearly reciprocate along the two elongated slots 11.

Specifically, the two swing rods 40 may be partially disposed in the recess 122, or may be entirely disposed in the recess 122. The two swing rods 40 are covered with the cover plate 60. The two elongated holes 61 are defined on the cover plate 60 to allow the second ends 42 of the two swing rods 40 to respectively linearly reciprocate along the two elongated slots 11. Thus, with the arrangement of the cover plate 60, not only can pinching hand be prevented, but also the normal motion of the swing rod 40 cannot be affected.

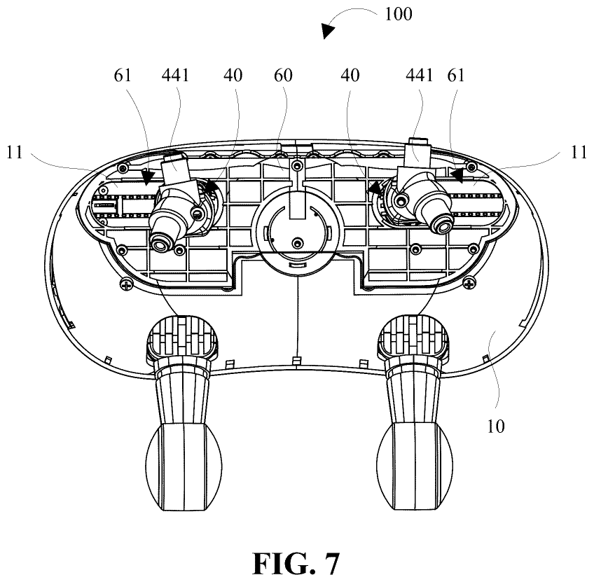

Referring to FIG. 7, in some embodiments, the width of the elongated slot 11 is greater than or equal to the diameter of the second end 42. The diameter of the second end 42 is greater than the width of the elongated hole 61.

Specifically, the width of the elongated slot 11 is greater than or equal to the diameter of the second end 42, to facilitate the second end 42 to linearly reciprocate in the elongated slot 11. In practical applications, the swing rod 40 may be abnormally stressed. For example, if the user forcefully pulls the massage head 50 outwards, the swing rod 40 is easy to be separated from the cover plate 60 when being abnormally stressed, resulting in a malfunction of the massage mechanism 100 and affecting use. Therefore, the diameter of the second end 42 is designed to be greater than the width of the elongated hole 61, so that the second end 42 may be clamped in the elongated hole 61, thereby effectively preventing the swing rod 40 from separating from the cover plate 60 when being abnormally stressed.

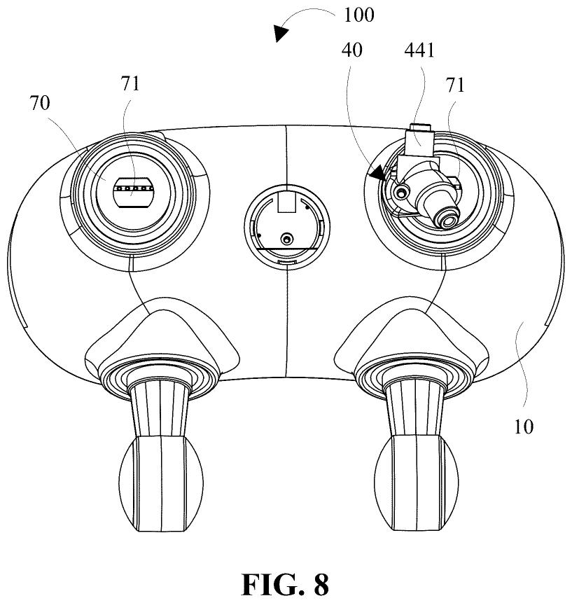

Referring to FIG. 7 and FIG. 8, in some embodiments, the massage mechanism 100 further includes a flexible housing 70. The flexible housing 70 covers the cover plate 60 at one side of the cover plate 60 opposite to the two swing rods 40. The flexible housing 70 defines two opening holes 71 for allowing the two massage heads 50 to extend out the flexible housing 70 respectively. Positions of the two opening holes 71 respectively correspond to middle positions of the two elongated holes 61. An opening size of each of the two opening holes 71 is less than an opening size of each of the two elongated holes 61.

Specifically, the flexible housing 70 is made of a flexible material, such as, silica gel. The flexible housing 70 covers the cover plate 60 at one side of the cover plate 60 opposite to the two swing rods 40. The two opening hole 71 are defined on the flexible housing 70, so that the two massage heads 50 can extend out. The opening size of each of the two opening holes 71 is less than the opening size of each of the two elongated holes 61. Thus, the two elongated holes 61 on the cover plate 60 can be blocked to prevent pinching hand.

Since the opening size of each of the two opening holes 71 is less than the opening size of each of the two elongated holes 61, the swing rod 40 may pull the flexible housing 70 during the motion of the swing rod 40. Therefore, the two opening holes 71 can be respectively defined at positions of the flexible housing 70 corresponding to the middle positions of the two elongated holes 61. In this way, excessive pulling of the flexible housing 70 can be avoided.

Referring to FIG. 1 to FIG. 3, in some embodiments, the massage mechanism 100 further includes two massage housings 80. The two massage housings 80 respectively cover two massage heads 50. An outer surface of each of the two massage housings 80 forms a diamond-like structure that is symmetrical about a central axis (as shown by a dotted line O₄ in FIG. 3) of each of the two massage housings 80.

Specifically, the outer surface of the massage housing 80 is designed to have a diamond-like structure, so that the massage housing 80 has a better touch feeling when being in contact with the skin of the user, and the massage comfort is improved.

Referring to FIG. 1 and FIG. 2, in some embodiments, the massage mechanism 100 further includes two massage housings 80. The two massage housings 80 respectively cover two massage heads 50. Each of the two massage housings 80 includes a first housing part 81 close to the target massage area and a second housing part 82 away from the target massage area. The first housing part 81 and the second housing part 82 are symmetrical about a central axis of each of the two massage housings 80. The first housing part 81 is a flexible massage housing. The second housing part 82 is a rigid massage housing.

Specifically, the flexible massage housing is made of a flexible material, such as, silica gel. The first housing part 81 close to the target massage area is designed as the flexible massage housing, so that the massage housing 80 has a better touch feeling when being in contact with the skin of the user, and the massage comfort is improved. The second housing part 82 away from the target massage area is designed as the rigid massage housing, so that the structural strength of the massage housing 80 can be improved.

Referring to FIG. 1, FIG. 2, and FIG. 7, in some embodiments, the two massage heads 50 are two groups of massage heads 50. Each of the two groups of massage heads 50 includes a first massage head 51 and a second massage head 52. The second connection arm 44 is provided with two extension portions 441 at one end of the second connection arm 44 away from the housing surface 12. The two extension portions 441 respectively extend from the second connection arm 44 to opposite sides of the second connection arm 44 in the width direction of the housing 10, and are gradually away from the housing surface 12. The first massage head 51 and the second massage head 52 are respectively fixed to the two extension portions 441. When the two groups of massage heads 50 each perform the yaw motion around the rotation axis parallel to the central axis of the eccentric wheel 30 in the preset angle region, two corresponding first massage heads 51 in the two groups of massage heads 50 are close to the target massage area and two corresponding second massage heads 52 in the two groups of massage heads 50 are away from the target massage area, or the two corresponding first massage heads 51 in the two groups of massage heads 50 are away from the target massage area and the two corresponding second massage heads 52 in the two groups of massage heads 50 are close to the target massage area.

Specifically, the two groups of massage heads 50 each perform the yaw motion around the rotation axis parallel to the central axis of the eccentric wheel 30 in the preset angle range. Two corresponding first massage heads 51 and two corresponding second massage heads 52 in the two groups of massage heads 50 alternately approach and move away from the target massage area, and respectively massage different regions of the target massage area. In this way, the two corresponding first massage heads 51 and the two corresponding second massage heads 52 in the two groups of massage heads 50 alternately massage the target massage area, so that after the user is massaged for a long time, it is not easy to wear the skin of the user, and the massage comfort is improved.

It can be understood that, in the process of the yaw motion of the two groups of massage heads 50, at least part of the process is fore-mentioned “the two corresponding first massage heads 51 in the two groups of massage heads 50 are close to the target massage area and the two corresponding second massage heads 52 in the two groups of massage heads 50 are away from the target massage area, or the two corresponding first massage heads 51 in the two groups of massage heads 50 are away from the target massage area and the two corresponding second massage heads 52 in the two groups of massage heads 50 are close to the target massage area”. In addition, the process of the yaw motion of the two groups of massage heads 50 may also include “the two corresponding first massage heads 51 in the two groups of massage heads 50 are close to the target massage area and the two corresponding second massage heads 52 in the two groups of massage heads 50 are also close to the target massage area”, “the two corresponding first massage heads 51 in the two groups of massage heads 50 are away from the target massage area and the two corresponding second massage heads 52 in the two groups of massage heads 50 are also away from the target massage area”, and other processes, which is not limited herein.

When the two groups of massage heads 50 each perform the yaw motion around the rotation axis parallel to the central axis of the eccentric wheel 30 in the preset angle range, the two groups of massage heads 50, as a whole, linearly reciprocate in the two elongated slots 11 following the second ends 42 of the two swing rods 40, respectively. Therefore, when the two groups of massage heads 50 are close to or away from each other as a whole, the two corresponding first massage heads 51 in the two groups of massage head 50 and the two corresponding second massage heads 52 in the two groups of massage heads 50 are alternatively close to and away from the target massage area.

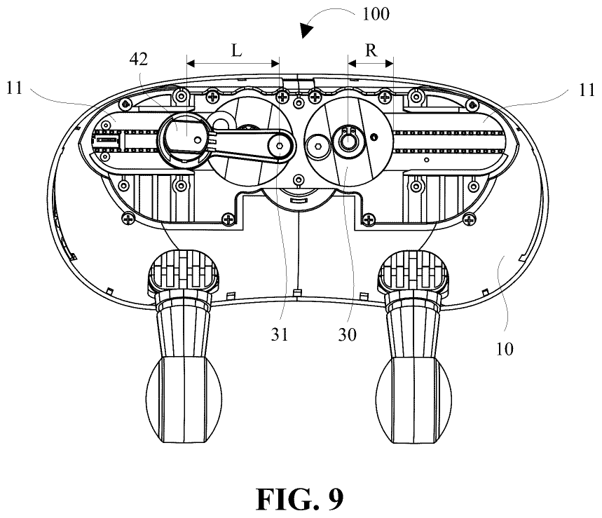

Referring to FIG. 9, in some embodiments, the length from the eccentric connection portion 31 to the second end 42 ranges from 30 mm to 50 mm. An eccentric radius of the eccentric wheel 30 ranges from 8 mm to 15 mm.

Specifically, the length from the eccentric connection portion 31 to the second end 42 is represented by L, which refers to the length from a central point of the eccentric connection portion 31 to a central point of the second end 42, and ranges from 30 mm to 50 mm. For example, the length L from the eccentric connection portion 31 to the second end 42 is 30 mm, 35 mm, 40 mm, 45 mm, 50 mm, or any other value between 30 mm and 50 mm, which is not limited herein. The eccentric radius of the eccentric wheels 30 is represented by R and ranges from 8 mm to 15 mm. For example, the eccentric radius R of the eccentric wheels 30 is 8 mm, 9 mm, 10 mm, 11 mm, 12 mm, 13 mm, 14 mm, 15 mm, or any other value between 8 mm and 15 mm, which is not limited herein. When the length/from the eccentric connection portion 31 to the second end 42 is set in a range of 30 mm to 50 mm, and the eccentric radius R of the eccentric wheels 30 is set in a range of 8 mm to 15 mm, an angle at which the massage heads 50 alternately perform yaw motion can be controlled in a proper range, thereby improving the massage comfort.

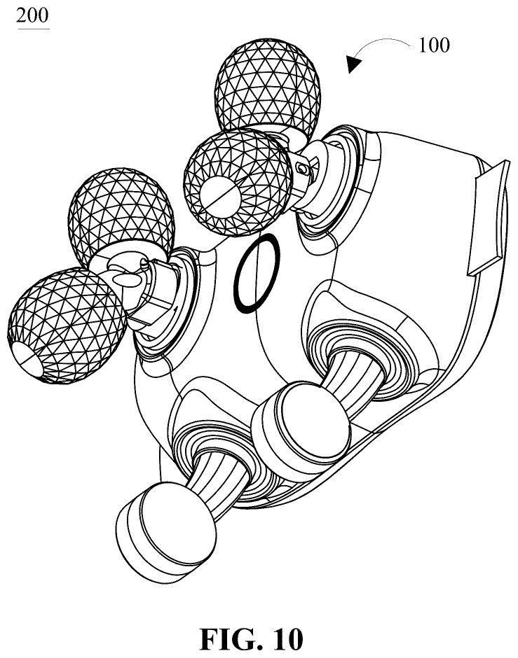

Referring to FIG. 10, a massager 200 is further provided in embodiments of the present disclosure. The massager 200 includes the massage mechanism 100 of any one of the foregoing embodiments. The massager 200 may be, such as, a neck massager for the user to massage the neck.

In conclusion, in the massage mechanism 100 and the massager 200 of embodiments of the present disclosure, the two eccentric wheels 30 and the two massage heads 50 are connected through the two swing rods 40, respectively. The massage head 50 is fixedly connected to the second end 42 of the swing rod 40. The second end 42 linearly reciprocates in the elongated slot 11. The massage head 50, along with the second end 42, performs a small amplitude of the yaw motion around the rotation axis parallel to the central axis of the eccentric wheel 30 in the preset angle range, and does not rotate 360° along with the eccentric wheel 30. Therefore, after the two massage heads 50 contact with the skin of the user, the two massage heads 50 only move on the fixed plane parallel to the plane where the elongated slots 11 are defined, and the movement amplitude of the two massage heads 50 at the target massage area is relatively small. Thus, after the user is massaged for a long time, it is not easy to wear the skin of the user, and the massage comfort is improved.

In the description of the present disclosure, it is necessary to understand that orientation or positional relations indicated by terms such as “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counter-clockwise” are orientation or positional relations based on the accompanying drawings, are only for facilitating description of the present disclosure and simplifying the description, rather than indicating or implying that the referred devices or elements must be in a particular orientation or constructed or operated in the particular orientation, and therefore they may not be construed as limiting the present disclosure. In addition, terms “first”, “second”, and the like are only used for description and cannot be understood as explicitly or implicitly indicating relative importance or implicitly indicating the number of technical features referred to herein. Therefore, features restricted by terms “first”, “second”, and the like can explicitly or implicitly include at least one of the features. In the description of the present disclosure, unless specified otherwise, “multiple” refers to “at least two”.

It may be noted that, unless specified or limited otherwise, in the description of the present disclosure, terms “mounting”, “coupling”, “connecting”, and the like referred to herein may be understood in broader sense. For example, coupling may be a fixed coupling, a detachable coupling, or an integrated coupling, may be a mechanical coupling, an electrical coupling, and may be a direct coupling, an indirect coupling through a medium, or a communication coupling between two components or an interaction coupling between two components. For those of ordinary skill in the art, the above terms in the present disclosure can be understood according to specific situations.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. In addition, a first feature “on”, “above”, or “on top of” a second feature may include an embodiment in which the first feature is right or obliquely “on”, “above”, or “on top of” the second feature, or just means that the first feature is at a height higher than that of the second feature; while a first feature “below”, “under”, or “on bottom of” a second feature may include an embodiment in which the first feature is right or obliquely “below”, “under”, or “on bottom of” the second feature, or just means that the first feature is at a height lower than that of the second feature.

The above disclosure provides many different embodiments or examples for implementing different structures of the present disclosure. In order to simplify the present disclosure, certain elements and settings are described above. However, these elements and settings are only examples and are not intended to limit the present disclosure. In addition, reference numerals and/or letters may be repeated in different examples in the present disclosure. This repeating is for the purpose of simplification and clarity and does not refer to relations between various embodiments and/or settings. In addition, examples of particular processes and materials are provided herein, but those of ordinary skill in the art can recognize applications of other processes and/or use of other materials.

Reference throughout this specification to “some embodiments”, “an embodiment”, “an example”, “a specific example”, or “some examples”, means that a particular feature, structure, material, or characteristic described in connection with the embodiment or example is included in at least one embodiment or example of the present disclosure. In this specification, exemplary descriptions of aforesaid terms are not necessarily referring to the same embodiment or example. In addition, the particular features, structures, materials, or characteristics may be combined in any suitable manner in one or more embodiments or examples.

Although embodiments of the present disclosure have been shown and described above, it would be appreciated by those of ordinary skill in the art that changes, modifications, replacements, and modifications can be made to these embodiments without departing from the principles and spirit of the present disclosure. The scope of the present disclosure is defined by the claims and equivalents thereof.

What is claimed is:

1. A massage mechanism, comprising:
a housing, wherein the housing is provided with two elongated slots;
a driving motor fixedly disposed at the housing;
two eccentric wheels disposed at the housing, wherein the two eccentric wheels are in transmission connection with the driving motor to rotate under the drive of the driving motor, each of the two eccentric wheels is provided with an eccentric connection portion, and the eccentric connection portion is spaced apart from a central axis of each of the two eccentric wheels;
two swing rods symmetrically arranged, wherein each of the two swing rods has a first end and a second end opposite to the first end in a length direction of each of the two swing rods, the first end is hinged to the eccentric connection portion to rotate 360° around the central axis of each of the two eccentric wheels along with the eccentric connection portion, and second ends of the two swing rods are respectively received in the two elongated slots to allow each of the second ends to linearly reciprocate and limit motion of each of the second ends in a direction perpendicular to the length direction of each of the two swing rods; and
two massage heads extending out of the housing and configured to massage a target massage area, wherein the two massage heads are fixedly connected to the second ends of the two swing rods respectively, and in a process of 360° rotation of the first end of each of the two swing rods around the central axis of each of the two eccentric wheels under the drive of each of two eccentric wheels, the two massage heads are close to or away from each other, and each are configured to perform a yaw motion around a rotation axis parallel to the central axis of each of the two eccentric wheels in a preset angle range.

2. The massage mechanism of claim 1, wherein the housing has a housing surface, the driving motor is disposed at one side of the housing surface facing an interior of the housing, and the two swing rods are disposed at one side of the housing surface facing an exterior of the housing; and
each of the two swing rods comprises a first connection arm and a second connection arm connected to the first connection arm, the first connection arm is hinged to the eccentric connection portion, the first connection arm extends from the first end to the second end and is close to the housing surface, and the second connection arm extends from the second end in a direction away from the housing surface to be fixedly connected one of the two massage heads.

3. The massage mechanism of claim 2, wherein a reinforcing structure is disposed at a connection of the first connection arm and the second connection arm; and
the reinforcing structure comprises a first reinforcing structure disposed in a length direction of the first connection arm and connected to the second connection arm; and/or
a second reinforcing structure disposed in a length direction of the second connection arm and connected to the first connection arm.

4. The massage mechanism of claim 2, wherein two through holes are defined on the housing surface, the interior of the housing is in communication with the exterior of the housing through the two through holes, and the two eccentric wheels are respectively disposed in the two through holes; and
each of the two eccentric wheels has a cam surface facing the exterior of the housing, and the eccentric connection portion extends from the cam surface and is at least partially located outside each of the two through holes to be hinged to the first end of each of the two swing rods.

5. The massage mechanism of claim 4, wherein there is a height difference between the cam surface and the housing surface, and the height difference is in a range of ±2 mm.

6. The massage mechanism of claim 2, wherein an angle between a length extension direction of the first connection arm and a length extension direction of the second connection arm ranges from 80° to 100°.

7. The massage mechanism of claim 1, wherein at least one rib is disposed in each of the two elongated slots and extends in a linear motion direction of the second end, each of the at least one rib has a rib top-surface facing an exterior of the housing, and the rib top-surface is configured to be in sliding fit with the second end when the second end linearly reciprocates along each of the two elongated slots; and
a plane that is flush with the rib top-surface in each of the two elongated slots is recessed towards an interior of the housing to define at least two oil storage grooves, and the at least two oil storage grooves and the at least one rib are alternately arranged in a width direction of each of the two elongated slots.

8. The massage mechanism of claim 7, wherein the rib top-surface is recessed towards the interior of the housing to define a plurality of oil storage holes, and the plurality of oil storage holes are defined at intervals in the linear motion direction of the second end.

9. The massage mechanism of claim 7, wherein two spaced ribs are disposed in each of the two elongated slots, and the two ribs are symmetrical in the width direction of each of the two elongated slots.

10. The massage mechanism of claim 1, further comprising a cover plate, wherein the housing surface is recessed towards an interior of the housing to define a recess, and the two swing rods are at least partially received in the recess and covered with the cover plate; and
the cover plate defines two elongated holes, and the two elongated holes respectively allow the second ends of the two swing rods to linearly reciprocate along the two elongated slots.

11. The massage mechanism of claim 10, wherein a width of each of the two elongated slots is greater than or equal to a diameter of the second end, and the diameter of the second end is greater than a width of each of the two elongated holes.

12. The massage mechanism of claim 10, further comprising a flexible housing, wherein the flexible housing covers the cover plate at one side of the cover plate opposite to the two swing rods; and
the flexible housing defines two opening holes for allowing the two massage heads to extend out of the flexible housing respectively, positions of the two opening holes respectively correspond to middle positions of the two elongated holes, and an opening size of each of the two opening holes is less than an opening size of each of the two elongated holes.

13. The massage mechanism of claim 1, further comprising two massage housings, wherein the two massage housings respectively cover the two massage heads, and an outer surface of each of the two massage housings forms a diamond-like structure that is symmetrical about a central axis of each of the two massage housings.

14. The massage mechanism of claim 1, further comprising two massage housings, wherein the two massage housings respectively cover the two massage heads, each of the two massage housings comprises a first housing part close to the target massage area and a second housing part away from the target massage area, the first housing part and the second housing part are symmetrical about a central axis of each of the two massage housings, the first housing part is a flexible massage housing, and the second housing part is a rigid massage housing.

15. The massage mechanism of claim 2, wherein the two massage heads are two groups of massage heads, each of the two groups of massage heads comprises a first massage head and a second massage head, the second connection arm is provided with two extension portions at one end of the second connection arm away from the housing surface, the two extension portions respectively extend from the second connection arm to opposite sides of the second connection arm in a width direction of the housing, and are gradually away from the housing surface, and the first massage head and the second massage head are respectively fixed to the two extension portions; and
when the two groups of massage heads each perform the yaw motion around the rotation axis parallel to the central axis of each of the two eccentric wheels in the preset angle range, two corresponding first massage heads in the two groups of massage heads are close to the target massage area and two corresponding second massage heads in the two groups of massage heads are away from the target massage area, or the two corresponding first massage heads in the two groups of massage heads are away from the target massage area and the two corresponding second massage heads in the two groups of massage heads are close to the target massage area.

16. The massage mechanism of claim 1, wherein a length from the eccentric connection portion to the second end ranges from 30 mm to 50 mm, and an eccentric radius of each of the two eccentric wheels ranges from 8 mm to 15 mm.

17. The massage mechanism of claim 1, wherein the rotation axis parallel to the central axis of each of the two eccentric wheels is a central axis of the second end.

18. A massager, comprising a massage mechanism, wherein the massage mechanism comprises:
a housing, wherein the housing is provided with two elongated slots;
a driving motor fixedly disposed at the housing;
two eccentric wheels disposed at the housing, wherein the two eccentric wheels are in transmission connection with the driving motor to rotate under the drive of the driving motor, each of the two eccentric wheels is provided with an eccentric connection portion, and the eccentric connection portion is spaced apart from a rotation axis of each of the two eccentric wheels;
two swing rods symmetrically arranged, wherein each of the two swing rods has a first end and a second end opposite to the first end in a length direction of each of the two swing rods, the first end is hinged to the eccentric connection portion to rotate 360° around the rotation axis of each of the two eccentric wheels along with the eccentric connection portion, and second ends of the two swing rods are respectively received in the two elongated slots to allow each of the second ends to linearly reciprocate and limit motion of each of the second ends in a direction perpendicular to the length direction of each of the two swing rods; and
two massage heads extending out of the housing and configured to massage a target massage area, wherein the two massage heads are fixedly connected to the second ends of the two swing rods respectively, and in a process of 360° rotation of the first end of each of the two swing rods around the rotation axis of each of the two eccentric wheels under the drive of each of two eccentric wheels, the two massage heads are close to or away from each other, and each are configured to perform a yaw motion around a rotation axis parallel to the rotation axis of each of the two eccentric wheels in a preset angle range.

19. The massager of claim 18, wherein the housing has a housing surface, the driving motor is disposed at one side of the housing surface facing an interior of the housing, and the two swing rods are disposed at one side of the housing surface facing an exterior of the housing; and
each of the two swing rods comprises a first connection arm and a second connection arm connected to the first connection arm, the first connection arm is hinged to the eccentric connection portion, the first connection arm extends from the first end to the second end and is close to the housing surface, and the second connection arm extends from the second end in a direction away from the housing surface to be fixedly connected one of the two massage heads.

20. The massager of claim 18, wherein at least one rib is disposed in each of the two elongated slots and extends in a linear motion direction of the second end, each of the at least one rib has a rib top-surface facing an exterior of the housing, and the rib top-surface is configured to be in sliding fit with the second end when the second end linearly reciprocates along each of the two elongated slots; and
a plane that is flush with the rib top-surface in each of the two elongated slots is recessed towards an interior of the housing to define at least two oil storage grooves, and the at least two oil storage grooves and the at least one rib are alternately arranged in a width direction of each of the two elongated slots.
